(19) United States
(12) Patent Application Publication
(10) Pub. No.: US 2008/0083131 A1
(43) Pub. Date: Apr. 10, 2008

(54) Goft cart glove holder-dryer

(76) Inventor: Daniel Joseph Wess, Bedford, TX (US)

Correspondence Address: Danny Wess, 64 Morrow dr, Bedford, TX, 76021, US

(21) Appl. No.: 11/543,176

(22) Filed: Oct. 4, 2006

(51) Int. Cl. F26B 25/18

(52) U.S. Cl. 34/239

(57) ABSTRACT

A thin molded plastic cylinder oval shaped beak opening configured main body to releasable hold an interior wristband of a golf glove along at least a portion of an outer circumference of the main body such that air is directed through the preferably tubular C-shaped neck affixed to the main body and through to the glove. The clamp portion is C-shaped with affixed extending neck, the clamp is adapted to grip securely around a portion of the vertical tubular shaped golf cart frame member for mounting purposes.

### CROSS-REFERENCE TO RELATED APPLICATION

This application claims the benefit of provisional patent application Ser. No. 60/658,676 filed 2005 Mar. 16 by the present inventor.

### BACKGROUND OF THE INVENTION

1. Field of Invention

The present invention is directed to a golf glove holder-dryer adapted to be mounted to the frame of a golf cart, the holder-dryer configured to direct air through the glove thereby holding and drying the glove.

2. Background Art

Golf gloves are widely used by golfers to facilitate gripping golf clubs except during putting. Unfortunately, because golf gloves are typically made of leather or a cloth and leather combination, a golf glove can quickly become wet from golfers perspiring hand during warm, humid weather and or from body movement. When the golf glove gripping area is saturated with perspiration, its gripping ability is markedly decreased. Therefore, golfers have devised various methods of drying their golf gloves during the course of play, including blowing into the glove, hanging the glove over the head of a club in their golf bag and tying the glove to the golf cart when the glove is not in use. Some golfers use multiple gloves, switching between gloves, as the gloves become wet with perspiration. This strategy requires the golfer to purchase additional gloves. Furthermore, if a golfer tosses the wet gloves into his or her golf bag or stuff the wet gloves into his or her pockets, the wet gloves may become mildewed because of lack of air circulation. Even if such gloves do eventually dry, the leather stiffens upon drying causing the gloves to be stiffening into a contorted, rolled up or out of shape condition. This is detrimental to the leather and makes the glove difficult for the golfer to get a proper grip on a golf club and makes it harder to put on for the next round of golf. What is needed is a simple, economical device for allowing a golf glove to dry during the course of play during periods when the glove is not being used by the golfer. What is also needed is a device that provides a convenient place for a golfer to place his or her glove while not in use during around of golf.

### SUMMARY OF THE INVENTION

The present invention is directed to a golf glove holder-dryer that is adapted to be mounted to a golf cart body frame member. The golf glove holder is configured to direct air into a golf glove releasable affixed to the holder-dryer. As the golf cart is driven, a flow of air is directed into an interior of the golf glove by the holder-dryer to aid in drying the glove when not in use. Even when the cart is moving, normal breezes cause air to be directed into the glove interior by the holder-dryer thereby drying the glove without movement of the cart. The golf glove holder-dryer includes a main body, neck and an attachment member affixed thereto for attachment of the holder-dryer to a golf cart body frame member. The golf cart body frame member that the holder-dryer is attached to is typically a ¾ inch or 1 inch square tubular steel member extending from the corners adjacent from one another vertically between the golf cart body and the roof portion of the golf cart body. The main body of the golf glove holder-dryer is preferably cylindrical beak. At the second end of the main body where the neck and the main body meet, the cylindrical beak starts flat and extends upward and outward with a top and a bottom portion, which is the one end of the main body. The one end of the main body is wider than the second end and the one end of the main body is oval in shape. The golf glove holder-dryer is configured to releasable hold a wrist portion of a golf glove along the outer circumference of the main body such that air flowing through the neck and main body is directed into the glove. Preferably, the golf glove holder-dryer releasable hold a cotton or a leather wristband that is made to stretch, typically elastic sewn along an inward facing wrist portion of a golf glove. The main body is longitudinally facing outward 30 degrees parallel to the golf cart body. The main body is preferably a length of plastic having a outer diameter of 1¾ inch by 2¾ inch and a length of 2½ inches.

The neck is affixed in between the main body and the attachment member. The neck preferably C-shaped tubular squared plastic. The neck has an opening where air is funneled into the longitudinal C-shaped neck portion and delivered into the main body and into golf glove region. The neck and the opening are longitudinally facing outward 30 degrees parallel to the golf cart body. The neck is 1⅛ inch in width and 2 inches in length.

The attachment member is affixed to the neck and includes a clamp portion for attachment to a tubular frame portion of the golf cart. Preferably the clamp portion is C-shaped in cross section with flexible L-shaped extending arms adapted to wrap around a portion of the frame. The strength of the extending arms forces the arms against the frame thereby securing the attachment member and thereby the golf glove holder-dryer onto the golf cart frame. The clamp portion is mounted to the frame perpendicular to the golf cart body. The attachment member is preferably 30 degrees from the golf cart frame member and facing outward parallel of the golf cart body. The clamp portion advantageously is fabricated of a material such as plastic or rubber and is securable to both ¾ inch and 1 inch square cross section tubular frame members. These are the two sizes, which are utilized by the vast majority of golf cart manufacturers for golf cart body frame support members. In one exemplary embodiment, the clamp portion is oriented 30 degrees perpendicularly to the neck and main body. This would be used where the clamp portion is to be attached to a vertically oriented golf cart body frame member. In such an embodiment, a longitudinal axis of the neck and main body portion is oriented generally 30 degrees parallel to a path of travel of the golf cart, i.e., the parallel to the ground, such that, as the golf cart moves forward, air is funneled through the neck and main body and forced into the golf glove and cause it to balloon open from air flow into the glove interior. If it were desired to mount the holder-dryer onto a horizontally oriented golf cart body, the clamp portion would be oriented 30 degrees parallel to the neck and main body. In such an embodiment, the longitudinal axis of the neck and main body portion is again oriented generally parallel to the path of travel of the golf cart so that movement of the golf cart in a forward direction causes air to be funneled through the neck and main body into the glove interior. These and other objects, advantages and features of the invention will become understood from a detailed description of an exemplary embodiment of the invention, which is described in conjunction with the accompanying drawings.

### DRAWINGS—FIGURES

FIGS. 1a to 3b is perspective view of various aspects of the back, top, front, bottom, inside and outside views of the main body, neck and attachment member.

FIG. 4 is a side view of the golf glove holder-dryer of the main body, neck, and the attachment member with a golf glove attached to the main body.

FIG. 5 shows a front, top, outside perspective view of the golf glove holder-dryer of the main body, neck, and the attachment member with a golf glove attached to the main body.

FIG. 6a to 8b is perspective view of various aspects of the back, top, front, bottom, inside and outside views of the main body, and the attachment member.

FIG. 9 is a side view of the golf glove holder-dryer of the main body and the attachment member with a golf glove attached to the main body.

FIG. 10 shows a front, top, outside perspective view of the golf glove holder-dryer of the main body and the attachment member with a golf glove attached to the main body.

FIG. 11a-12b is perspective views of various aspects of the back, top, front, and bottom, inside and outside views of the main body and attachment member.

FIG. 13 is a side view of the golf glove holder-dryer of the main body and the attachment member with a golf glove attached to the main body.

FIG. 14 shows a front, top, outside perspective view of the golf glove holder-dryer of the main body and the attachment member with a golf glove attached to the main body.

### DETAILED DESCRIPTION OF THE PREFERRED EMBODIMENTS

### First Preferred Embodiment

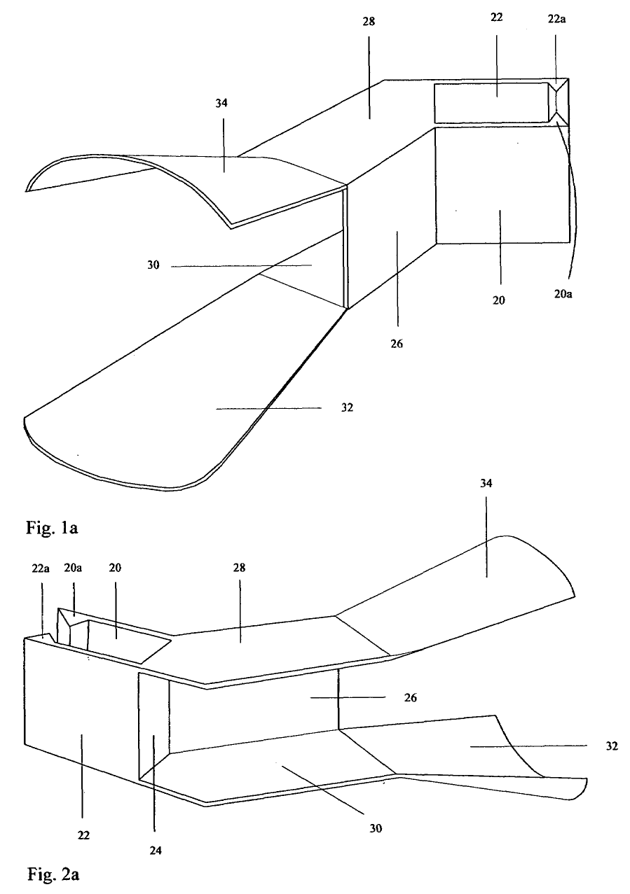

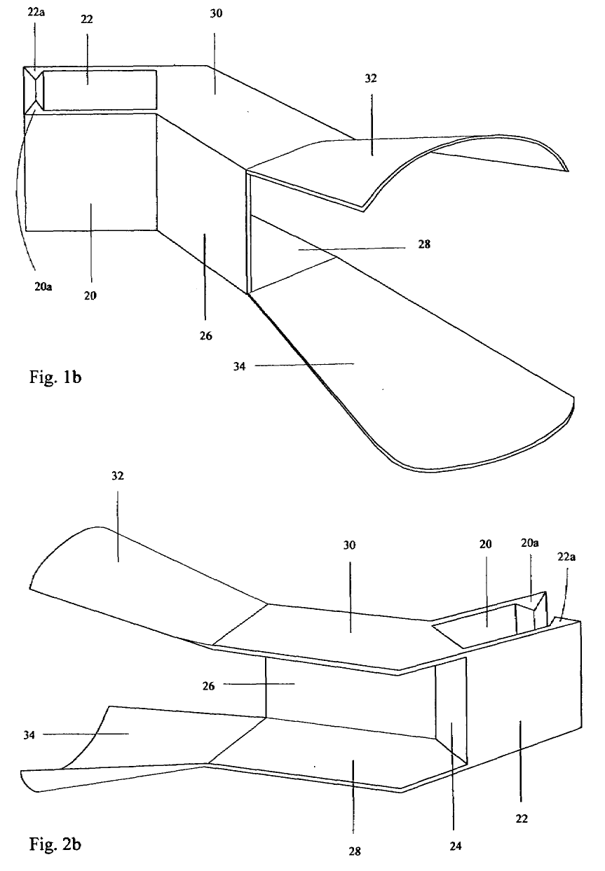

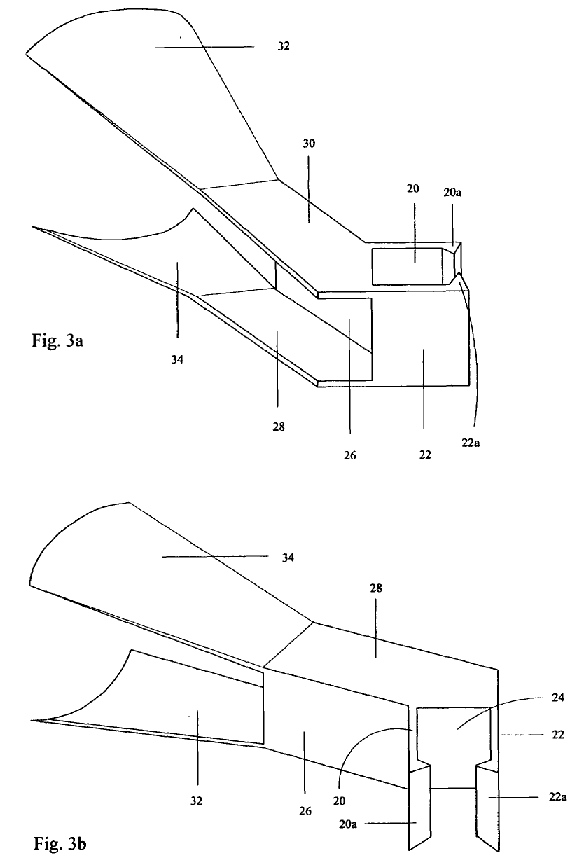

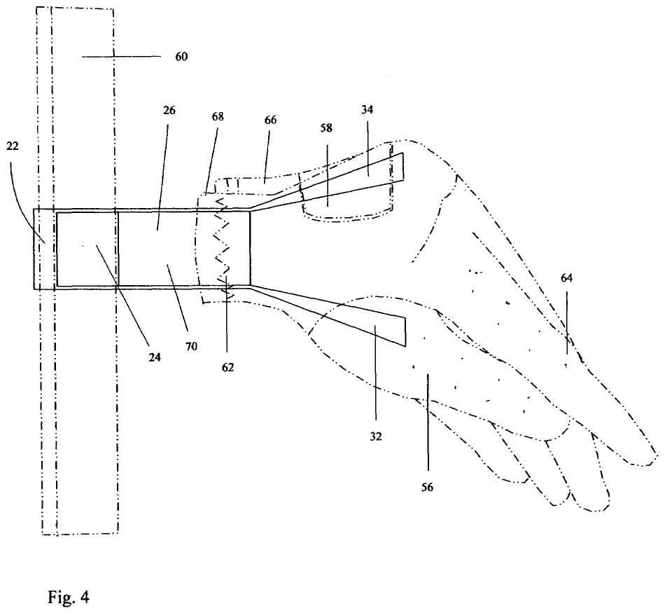

Turning to the drawings FIGS. 1a-3b show a first embodiment of a golf glove 56 holder-dryer of the present invention. The holder-dryer is releasable mounted to a vertical tubular frame member 60 of a body of a typical gas or electric engine golf cart. The tubular frame member 60 is typically square in cross section and generally from the corners and extends vertical between the golf cart body and roof portion of the golf cart. The tubular frame member 60 is typically ¾ inch or 1 inch in outer width. The golf glove holder-dryer releasable holds a golf glove 56 and as will be described below, aids in drying the glove 56 when the glove 56 is not in use by a golfer. While the holder-dryer is show in FIGS. 4&5 mounted to a frame member 60 of the golf cart thereby making it convenient for a golfer driving the cart to attach and remove his or her glove 56 from the holder-dryer may be advantageously affixed to any generally vertically oriented frame member 60 of the golf cart body.

The golf glove holder-dryer includes a main body, a neck and an attachment member affixed thereto for attachment of the holder-dryer to the golf cart frame member 60. The main body of the golf glove holder-dryer is preferably cylindrical oval beak 32,34 in shape, which includes an upper and a lower beak 32,34. Other non-circular cross sectional shapes could alternatively be used. The main body preferably a lightweight, high impact, durable material. One preferred material for the main body is inexpensive and readily available plastic material. Typical dimensions of the main body beaks 32,34 are longitudinally facing outward 30 degrees parallel to the golf cart body path. The top and bottom beaks 32,34 are adjacent from one another with openings on each side of the main body. The second end of the main body beak affixed to the one end of the neck is flat 1⅛ inch in width, the beak 32,34 extends 10 degrees outwards at the same time the beaks 32,34 gradually become wider in a oval shape to the one end of the main body beaks 32,34. The preferred length of plastic of 2½ inches and an outer oval diameter of 1¾ inch by 2¾ inches. With a preferred wall thickness of a ⅛ of an inch. The same measurements apply for the adjacent beak 34 of the main body. A wall of the main body includes a smooth suffice on both outer and inner sides of the beaks 32, 34. A perforated, rough or affixed material such as sandpaper may also be used. The smooth surface is adapted to releasable to hold a cotton or a leather wrist band 62 that is made to stretch, typically elastic sewn along an inward zigzagging style, facing the wrist end portion of a golf glove 56, which enables the glove 56 to be taunt against the beaks 32,34. The wristband 62 is generally a soft pile material, which functions as the eye opener to the hand. The golf glove normally includes a U-shaped slit 66 or a V-shaped split 66 extending longitudinally through the wrist end 68 of the glove 56 and an adjustment strap 58 to make it facilitate putting on and taking off of the golf glove 56. The adjustment strap 58 is made with a plurality of small J-shaped nylon hooks extending a base of the adjustment strap 58 material. Suitable nylon material adjacent from the J-hooked material is a soft fussy eye material. VELCRO™ brand nylon hook and eye material (VELCRO™ Brand hook material). The glove 56 has a top and a bottom adjustment strap 58. The top being the J-hooked and the bottom being the eye material. When the J-hooked and the eye material touch one another it creates secure hook and eye attachment bond securing the glove to the main body. Via a hook and eye attachable adjustment straps 58. Advantageously, when the adjustment strap 58 is loosen to allow a golfer to remove the glove 56, the U or V-shaped slit 66 in the wrist end 68 of the golf glove 56 makes it easy to attach the glove 56 to the holder-dryer. The wristband 62 affixed to the beaks 32,34 grabbing the wrist end 68 and wrist band 62 of the glove 56 near one end of the wrist end 68 positioning the end 68 of the wrist band and pushing it against the upper and lower beaks 32,34 until both ends of the wrist band 62 are covering the upper and lower beaks 32,34 and attaching the adjustment straps 58. Which at that point, the entire wristband 62 is affixed to the beaks 32,34 and the glove 56 is thereby firmly secured to the main body. With the holder-dryer mounted to the golf cart frame member 60 at a 30-degree angle makes it convenient for a golfer standing next to the cart or sitting on the golf cart seat to attach or detach a golf glove 56 to or from the holder-dryer and also the main body of the holder-dryer is not an obstruction or in no way in the path of a golfer entering or exiting the seats of a golf cart.

To remove or release the glove 56 from the main body the golfer simply grabs a hold of the golf glove 56 fingers longitudinal adjacent from the wrist end 68 and pulls the glove 56 away from the holder-dryer, In effect will dislodge the adjustment straps 58 creating a peeling motion. The beaks 32,34 of the main body at which will act as a peeling device due to the circumference and the 10 degree angle of the beaks 32,34 in effect the friction of the pulling motion will dislodge or peel the adjustment straps 58 until the golf glove 56 detaches from the main body. In some cases the VELCRO™ Adjustment straps 58 have to much of a bond therefore will not release, in effect the elastic in the wrist band 62 of the golf glove 56 will stretch and enabling the glove to pull off the holder-dryer.

The circumference of the beaks 32,34 is slightly greater than the circumference of the wristband 62 to hold the glove sturdy through heavy winds and driving conditions, also to make it easier to affix and release the glove 56 from the main body. A typical golf glove 56 has about a 7.5 inch wrist band length when fully opened from the adjustment straps 58 and from the U-shaped or V-shaped slit 66. When the U-shaped or V-shaped slit 66 are fully closed the circumference is approximately 1½ inches, while the circumference of the beaks 32,34 are as follows, the width of the second end starts at 1⅛ inch and extends to the first end of the main body approximately 2½ inches. The beaks 32,34 does not damage the wrist end 68, wrist band 62, or interior region of the golf glove 56 and therefore may be attached and remove from the main body over and over with no harm to the golf glove 56. A small central longitudinal opening or passage of the main body extends between the first end of the main body and defined by the second end of the main body. The longitudinal opening is defined by inner surface beaks 32,34 of the main body, which opens the wrist band 62 and directs and funnels air 70 into an interior region of the golf glove 56. The first end of the main body faces outward longitudinal 30 degrees of the golf cart path; that is, it faces the direction the golf cart moves when going forward. The air 70 funneling effect of the main body is dramatic with forward movement of the golf cart. When the golf cart is moving forward, the glove 56 balloons open as a result of air 70 rushing into the glove 56 interior region. Golf gloves 56 are typically fabricated of a combination of supple leather for the fingers and palm areas which define a gripping area for contacting a golf club grip and a soft cotton and or leather for the remainder of the glove 56. The leather is perforated with many small holes 64 for ventilation and facilitating drying. The air 70 funneled into the glove 56 interior region by the neck and main body escapes through the leather perforations and through any cotton material thereby rapidly drying the glove 56 as the golf cart is driven forward. However, even when the golf cart is not moving, ambient wind is funneled through the neck and main body passage and aids in drying the glove 56.

While my above description contains many specifications, these should not be construed as limitations on the scope of the invention, but rather as an exemplification of the first preferred embodiment thereof. Many other variations are possible. For example the dimensions of the main body may comprise of a larger size and shape. The beaks 32,34 may comprise of being shorter or longer and the width may be wider or thinner. The circumference of the cylindrical oval shaped beak 32,34 opening where air 70 is funneled to the interior region of the glove 56 may comprise of a larger opening. Also the cylindrical oval shaped beaks may comprise of a continues circle with out openings on the sides. A motorized fan may be attached inside the air 70 funnel opening to force air 70 into the glove 56 region for fast drying while the glove is not in use and when the golf cart is not being driven; for example, a good opportunity would be when a golfer is putting. The golf glove holder-dryer may also comprise of just a J-hook shaped, which would be mounted to the golf cart frame member 60 and the golf glove is attached through the slit of the golf glove 56. Also advantageously the reader will see that the golf glove holder-dryer permits any size golf glove 56 to be attached; it allows left or right handed to de attached; it provides mounting capability of the golf glove holder-dryer on either the drivers side frame member or the passenger side frame member; it allows a convenient and logical place to hold a glove; it also allows any type of color to utilized and any type of surface to be used such as rough, smooth, textured, etc.

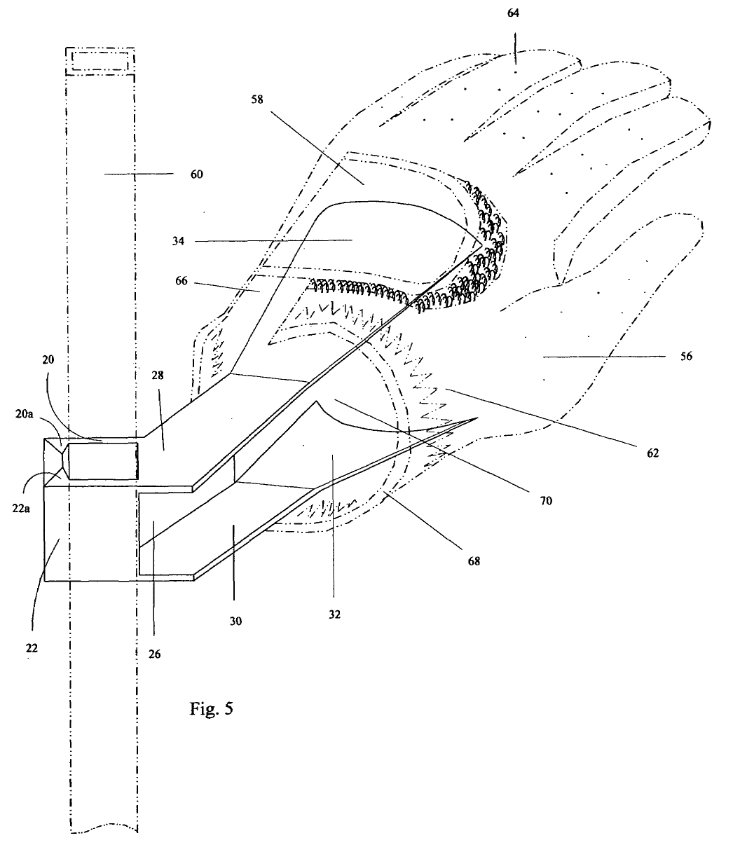

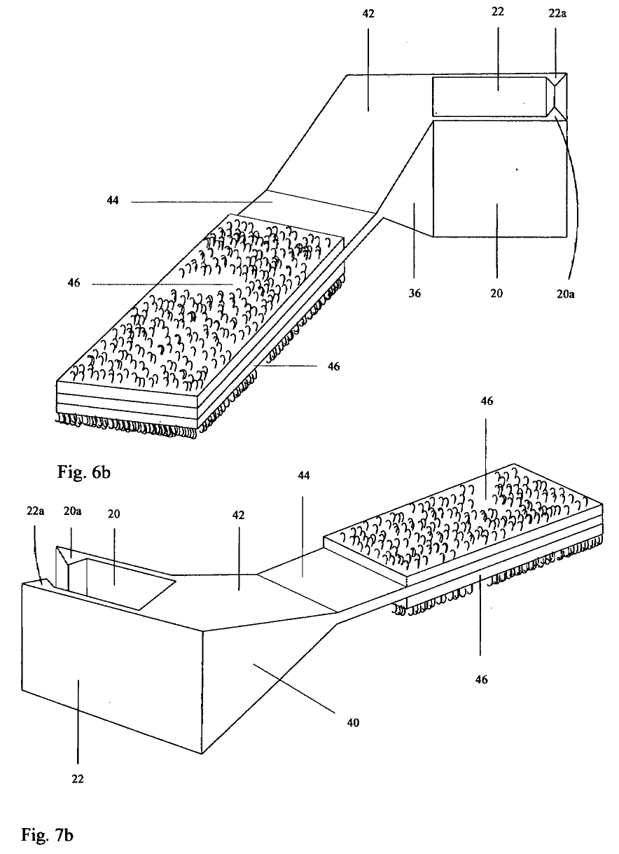

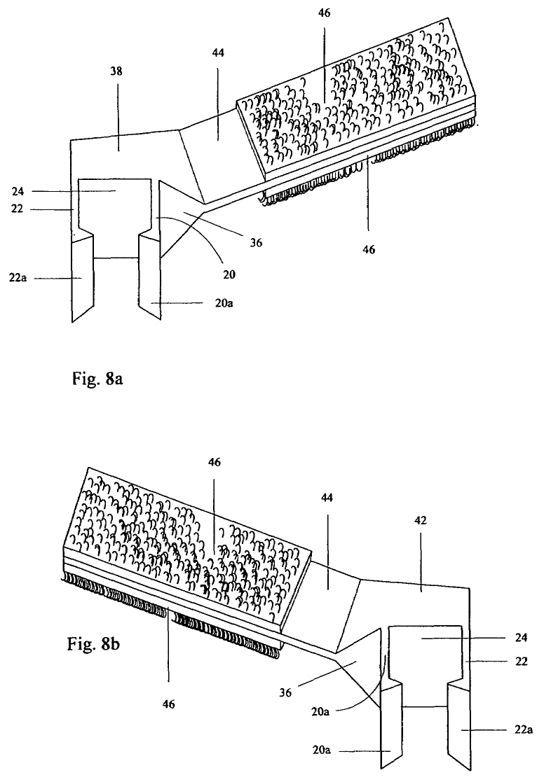

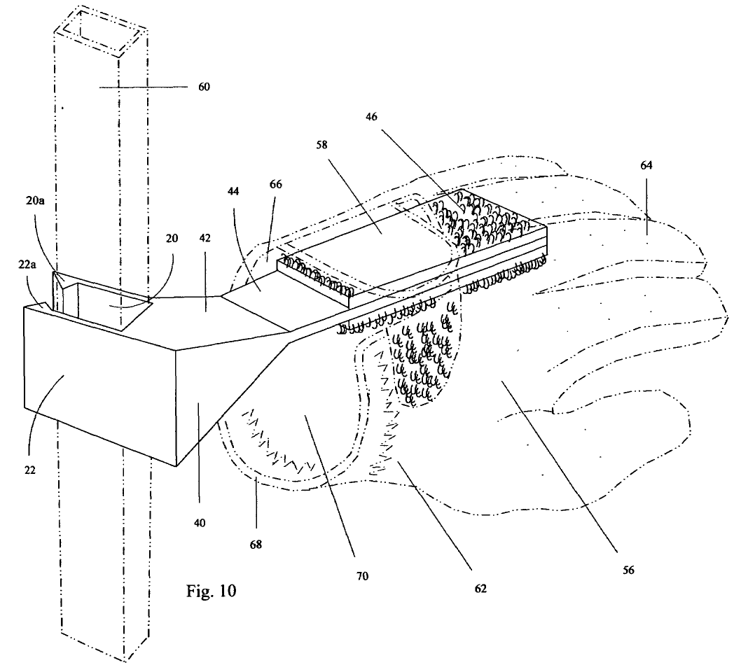

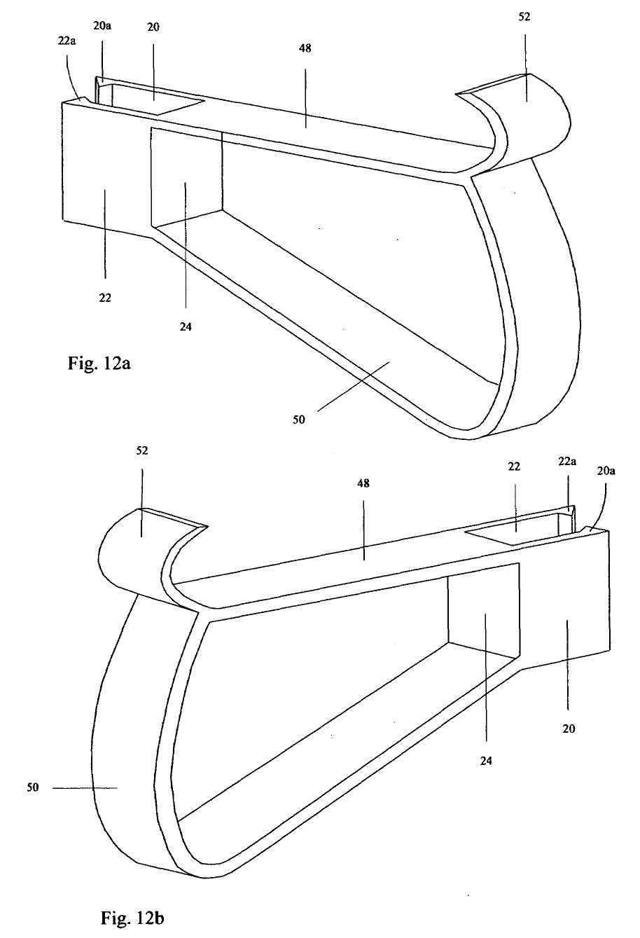

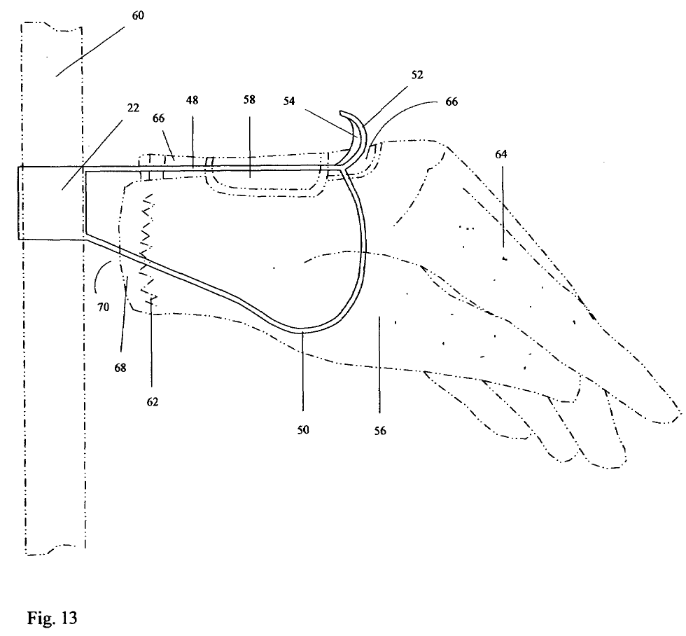

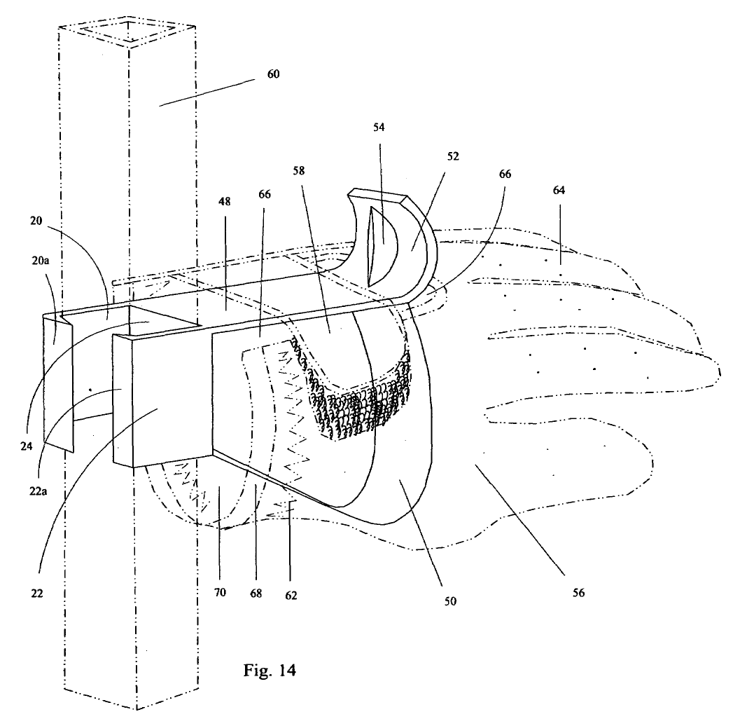

Accordingly, the scope of the invention should be determined not by the embodiments illustrated, but by the appended claims and their legal equivalents. The neck FIG. 1a-5 affixed between the main body and attachment member. The neck is preferably tubular C-shaped. The neck, preferably straight flat plastic has a ceiling 28, floor 30, a base 24 and a air 70 wall 26, although round, oval shapes and other non circular or square shapes could alternatively be used. The material for neck is the same as the main body. Typical dimensions of the neck would be 1⅛-inch width by 2¼ inch in length. With a wall thickness of ⅛ of an inch. The length and width may very in size. The neck and the main body are 30 degrees longitudinal at the second end of the neck where the neck and the attachment member meet. The angle may vary in degrees. The neck includes three sides, a ceiling 28, a floor 30 and an air 70 wall 26. The ceiling 28 is a flat surface and when the holder-dryer is mounted on the adjacent side of the golf cart the ceiling 28 becomes the floor 30 and vice versa of the floor 30 becoming the ceiling 28, the air 70 wall 26 is the inside of the holder-dryer whether the golf glove holder-dryer is mounted on either side of the golf cart. The air 70 wall 26 has no adjacent wall 26. The opening is there to allow air 70 to funnel in the neck to the interior region of the golf glove 56. Therefore the air 70 wall 26 acts as a collector of air 70. The small longitudinal opening or passage extends between an opening defined by a second end of the neck and an opening defined by the first end of the neck. The longitudinal opening is defined by an inner surface of the neck directs and funnels air 70 into the second end of the neck and then into the first end of the neck to the main body or the interior region of the glove 56. The longitudinal second and first ends face forward yet 30 degrees of an angle in the direction the cart moves when going forward The air 70 funneling effect of the neck is dramatic with forward movement of the golf cart. When the golf cart is moving forward, the glove balloons open as a result of the air 70 rushing into the glove 56 interior region. Advantageously, the neck allows more space between the main body and the attachment member, which gives more room for the wrist end 68. Interns frees the glove from rubbing against the golf cart frame member, which may cause damage to the glove 56 and may not allow air 70 to funnel into the interior region of the glove 56. The C-shaped neck funnels more air 70 into the main body due to the opening and the 30-degree angle of the neck from the attachment member. The golf cart holder-dryer is facing away from the hood or front cover of the golf cart. The hood or front cover is part of the golf cart that extends from the front driver side located next to the golf cart frame member 60 to the front passenger side of the golf cart frame member 60, therefore by having a 30 degree angle the golf glove holder-dryer will not impede the hood or front cover when attaching or detaching the golf glove holder-dryer from the golf glove frame member 60 and attaching or detaching a golf glove 56 from the golf glove holder-dryer. Also the holder-dryer may comprise of any other type of angled shape, such as L-shaped to allow room for operation of the golf glove holder-dryer. Advantageously, when the cart is moving forward the angle neck and main body acts as an air 70 funneling system, collecting air 70 and rushing it to the interior region of the glove 56, also the neck of the holder-dryer is not an obstruction or in no way in the path of a golfer entering or exiting the seats of a golf cart. While my above description contains many specifications, these should not be construed as limitations on the scope of the invention, but rather as an exemplification of the second preferred embodiment thereof. Many other variations are possible. For example the dimensions of the neck may comprise of a larger size and shape. The ceiling 28, floor 30 and air wall 26 may comprise of being shorter or longer and the width may be wider or thinner. The circumference of the air 70 funnel opening where air 70 is funneled to the interior region of the glove 56 may comprise of a larger opening. Also the air 70 funnel opening may comprise of a circular shaped opening or any other functional shape. Accordingly, the scope of the invention should be determined not by the embodiments illustrated, but by the appended claims and their legal equivalents. The attachment member is affixed to the neck and includes a clamp portion for attachment to the tubular frame member 60 of the golf cart. Preferably, the clamp portion is fabricated to a sturdy or flexible, waterproof and durable plastic. Such as the same material in which the neck and main body are constructed out of. Durable rubber may also be used, about 1 inch in width and length and from vertically top to bottom approximately 1⅛ inch and is C-shaped in cross section. As can be seen in FIG. 1a-14. The clamp portion includes a base 24, and has a pair of extending arms 20,22 extending perpendicularly from the base 24. The extending arms 20,22 include 45-degree angle L-shaped tip portions 20a, 22a, which are perpendicular to the general extent of the extending arms 20,22 The configuration of the clamp portion is such that the base 24 and the extending arms 20,22 fully contact three sides 20,22,24, of the four sides of the frame member 60 and the tip portion 20a, 22a, contact a portion of the fourth side to provide large surface area of contact between the attachment member and the frame member 60. The clamp portion is releasably affixed to the frame member 60 by the tip portions 20a, 22a, which when applied to the frame member 60 forces an inner surface of the base 24 against the frame member 60 side, forces the inner surface of the extending arms 20,22 against the frame member 60 sides and forces respective inner surface of the extending arms 20,22 tip portion 20a, 22a against the frame member 60 side, thereby causing a frictional force clamping attachment between the clamp portion and the frame member 60. The respective outer surfaces of the extending arms 20,22 and respective outer surfaces tip portions 20a, 22a, and the base 24 of the attachment member wrap around securely and becomes affixed to the frame member 60, simply by pushing the C-shape clamp opening portion against the vertical frame member 60 in such that the attachment member is mounted horizontally and perpendicular to the golf cart path and the golf glove holder-dryer facing outward 30 degrees from the golf cart path. To release the clamping attachment simply use a finger and push or pull on the tip portions 20a, 22a away from the frame member 60. The tip portions 20a, 22a and extending arms 20,22 will separate from the frame member enabling the tip portions 20a, 22a to clear the frame member 60 and allows the golf glove holder-dryer to be pulled away from the frame member 60. One skilled in the art would appreciate that there are many alternative mechanical fastening structures that could be employed to secure the attachment member to frame member 60 of the golf cart. For example, the extending arms 20,22 off the attachment member, may also comprise of alternative attachment methods, such as a strap and buckle, a spring and hook structure, a VELCRO™ J-Hook material strap or elastic strap may be affixed to the extending arm 20 and extends perpendicularly to the other extending arm 22, pulled tight and pushed against the eye material strip to tighten and secure the clamp portion against the frame member 60.

While my above description contains many specifications, these should not be construed as limitations on the scope of the invention, but rather as an exemplification of the third preferred embodiment thereof. Many other variations are possible. For example; While the clamp portion is advantageously is fabricated of a hard sturdy or flexible material such as plastic or rubber and is securable to both ¾ inch and 1 inch square cross section tubular frame members 60 which are utilized by most golf cart manufacturers for golf cart body support members, it should be understood that the clamp portion of the present invention could easily be modified to be securable to frame members with circular cross sections for golf carts having such frame members by simply rounding out the interior surface 20,22,24,20a, 22a, to form a generally circular cross section instead of the C-shaped cross section shown in FIG. 1a-14. Basically, the attachment member may be easily fabricated to fit any shape and any size frame members and it is the intent of this application to cover all such modifications. Accordingly, the scope of the invention should be determined not by the embodiments illustrated, but by the appended claims and their legal equivalents.

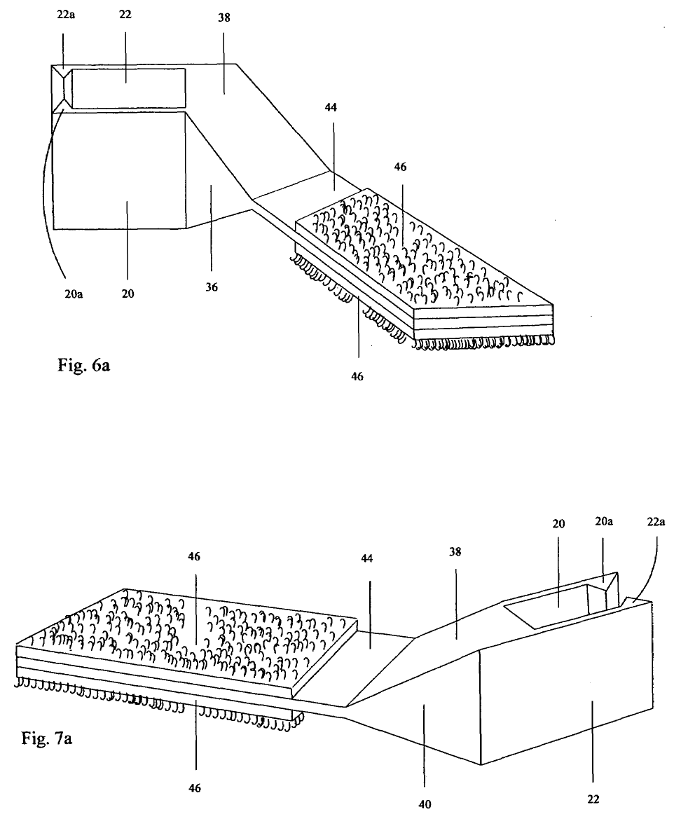

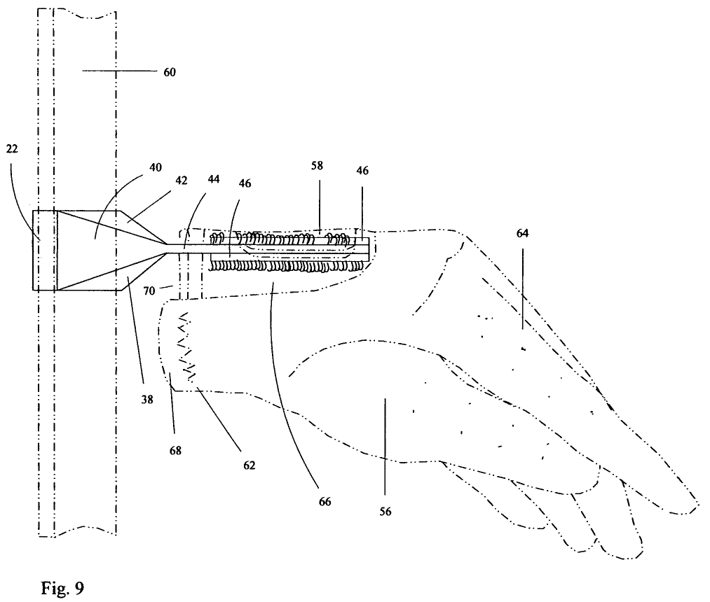

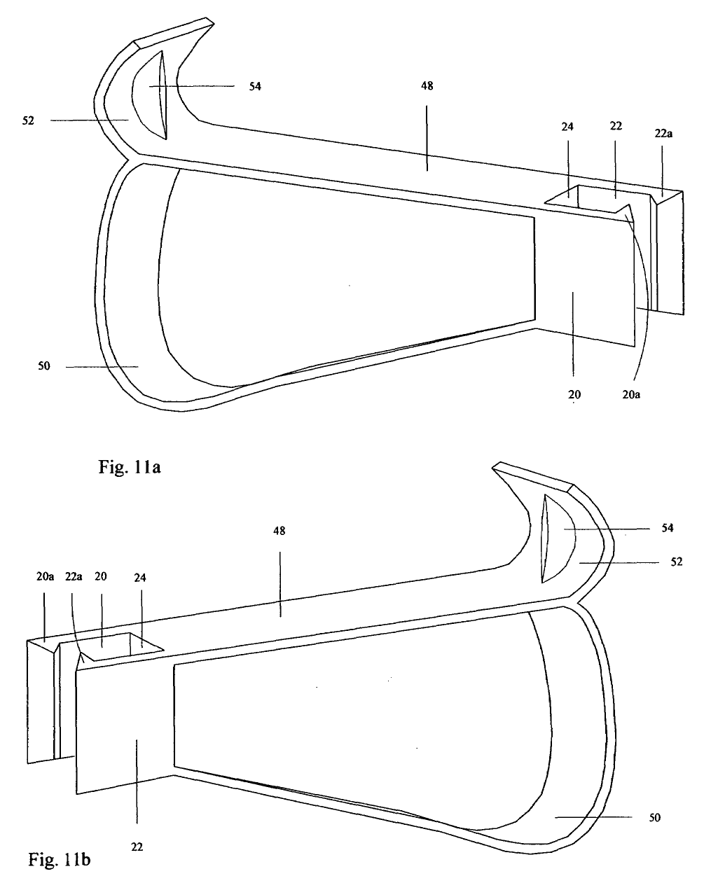

FIGS. 6a-14 Alternative Embodiments In the three preferred embodiments of the golf glove holder-dryer of the present invention where as the neck and main body portion act as an air 70 funnel and glove holder as previously described. In FIGS. 6a-10 the upper and lower neck 38, 42 has no air 70 funneled opening. Also the air funnels into the golf glove region simply by the glove naturally 56 hanging down from the nature of gravity 56. The wing 44 and Velcro wing 46 is the main body of the embodiment. The golf glove is attached via the adjustment straps 58 and affixed to the Velcro wing 46 as can be see in FIGS. 9 & 10. To attach the golf glove 56 simply press the Velcro adjustment straps 58 of the glove 56 to the Velcro wing 46, to release simply pull on the Velcro adjustment straps 58 of the glove 56. The attachment member is the same as the preferred embodiment previously described. In FIGS. 11a-14 of the alternative embodiment, the main body is the looped shaped arm 48 and elbow 50, with a C-shaped hook 52 and a wedge 54 located in the middle of the C-shaped hook 52. The golf glove 56 is wrapped around the arm 48 and elbow 50 in such that the hook 52 and wedge 54 allow the slit 66 of the golf glove 56 to pass through it making a grabbing effect on the adjustment straps securing the golf glove 56 to the main body. The wedge 54 is made to split the adjustment straps when the golf glove 56 is pulled away from the holder-dryer in order to release the glove 56 from the golf glove holder-dryer. In FIGS. 11a-14 the attachment member is mounted parallel to the golf cart path, again the attachment member may comprise of different methods of attaching to the golf cart, which were described in the preferred embodiments. While the present invention has been described with a degree of particularity, it is the intent that the invention includes all modifications and alterations from the disclosed embodiments falling within the spirit or scope of the appended claims.

I claim:

1. A golf glove holder-dryer adapted to be mounted to a frame member of a golf cart and releasable holding a golf glove such that air is directed into an interior region of the golf glove for drying the golf glove as the golf cart is driven forward, the golf glove holder comprising: a) a main body including a wall having a first end defining a first opening and a spaced apart second end defining a second opening and a central opening extending between the second and the first openings, the cylindrical oval beak in shape adapted to releasable engage a wrist end of the golf glove such that the band of material extends around at least a portion of the outer surface of the main body wall and the central opening of the main body is in fluid communication with the interior region of the glove; and b) a neck in such that a second end of the wall is disposed in a forward facing position with respect to the golf cart such that, as the golf cart is driven forward, air enters second end opening and is directed through the central opening and into the interior region of the golf glove; and c) an attachment member affixed to the neck, the attachment member including a clamping portion for releasable clamping the golf glove holder-dryer to the golf cart frame member.

2. The golf glove holder-dyer of claim 1 wherein the main body is cylindrical and the central opening is a central longitudinal opening extending between the second end opening and the first end opening.

3. The golf glove holder-dryer of claim 2 wherein the main body is a section of plastic having a diameter of at least 1¾ inch by 2¾ inch.

4. The golf glove holder-dryer of claim 1 wherein the neck is fabricated of plastic and affixed to the attachment member and the main body.

5. The golf glove holder-dryer of claim 5 wherein the neck defines a C-shape small longitudinal opening or passage extending between an opening defined by a second end of the neck and an opening defined by the first end of the neck.

6. The golf glove holder-dryer of claim 5 wherein the longitudinal opening is defined by an inner surface of the neck directs and funnels air into the second end of the neck and then into the first end of the neck to the main body or the interior region of the glove

7. The golf glove holder-dryer of claim 1 wherein the attachment member fabricated of plastic, with flexible extending arms and which is affixed to the neck.

8. The golf glove holder-dryer of claim 1 wherein the attachment member clamping portion includes a base and spaced apart first and second arms extending from the base and the first and second arms configured to contact and encircle a portion of the golf cart frame member, forcing the first and second arms and the base against the frame member thereby causing a frictional force clamping attachment between the clamp portion and the frame member.

9. The golf glove holder-dryer of claim 8 wherein the clamping portion is C-shaped in cross section and the first and second arms extend perpendicularly from the base for clamping to a frame member that is generally square in cross section.

10. The golf glove holder-dryer of claim 9 wherein the first and second arms include respective first and second tip portions which extend perpendicularly to a general extent of the first and second arms whereby the base, the first and second arms and the first and second tip portions taken together contact at least portions of all four sides of the square cross section frame member.

11. The golf glove holder-dryer of claim 1 wherein the attachment member-clamping portion is configured to releasable clamp to a golf cart frame member extending generally vertically with respect to ground surface that the golf cart is disposed upon.

12. The golf glove holder-dryer of claim 1 wherein the attachment member-clamping portion is configured to releasable clamp to a golf cart frame member extending generally horizontally with respect to ground surface that the golf cart is disposed upon.

13. A golf glove holder-dryer in combination with a golf glove, the golf glove holder-dryer adapted to be mounted to a frame member of a golf cart and releasable holding the golf glove such that air is directed into an interior region of the golf glove for drying the golf glove as the golf cart is driven forward, the golf glove holder-dryer and golf glove comprising: a) the golf glove including an inner surface defining an interior region adapted to receive a golfers hand and further including a band of absorbent material affixed to inner surface of the glove within the interior region adjacent a wrist end of the golf glove; and b) the golf glove holder-dryer including, 1) a main body including a wall having a first end defining a first opening and a spaced apart second end defining a second opening and a central opening extending between the second and the first openings, the cylindrical oval beak in shape adapted to releasable engage a wrist end of the golf glove such that the band of material extends around at least a portion of the outer surface of the main body wall and the central opening of the main body is in fluid communication with the interior region of the glove; and 2) a neck in such that a second end of the wall is disposed in a forward facing position with respect to the golf cart such that, as the golf cart is driven forward, air enters second end opening and is directed through the central opening and into the interior region of the golf glove; and 3) an attachment member affixed to the neck, the attachment member including a clamping portion for releasable clamping the golf glove holder-dryer to the golf cart frame member.

14. The golf glove holder-dryer of claim 13 wherein the main body is cylindrical and the central opening is a central longitudinal opening extending between the second end opening and the first end opening.

15. The golf glove holder-dryer of claim 14 wherein the main body is a section of plastic having a diameter of at least 1¾ inch by 2¾ inch.

16. The golf glove holder-dryer of claim 13 wherein the neck is fabricated of plastic and affixed to the attachment member and the main body.

17. The golf glove holder-dryer of claim 16 wherein the neck defines a C-shape small longitudinal opening or passage extending between an opening defined by a second end of the neck and an opening defined by the first end of the neck.

18. The golf glove holder-dryer of claim 16 wherein the longitudinal opening is defined by an inner surface of the neck directs and funnels air into the second end of the neck and then into the first end of the neck to the main body or the interior region of the glove

19. The golf glove holder-dryer of claim 13 wherein the attachment member fabricated of plastic, with flexible extending arms and which is affixed to the neck.

20. The golf glove holder-dryer of claim 13 wherein the attachment member clamping portion includes a base and spaced apart first and second arms extending from the base and the first and second arms configured to contact and encircle a portion of the golf cart frame member, forcing the first and second arms and the base against the frame member thereby causing a frictional force clamping attachment between the clamp portion and the frame member.

21. The golf glove holder-dryer of claim 20 wherein the clamping portion is C-shaped in cross section and the first and second arms extend perpendicularly from the base for clamping to a frame member that is generally square in cross section.

22. The golf glove holder-dryer of claim 21 wherein the first and second arms include respective first and second tip portions which extend perpendicularly to a general extent of the first and second arms whereby the base, the first and second arms and the first and second tip portions taken together contact at least portions of all four sides of the square cross section frame member.

23. The golf glove holder-dryer of claim 13 wherein the attachment member-clamping portion is configured to releasable clamp to a golf cart frame member extending generally vertically with respect to ground surface that the golf cart is disposed upon.

24. The golf glove holder-dryer of claim 13 wherein the attachment member-clamping portion is configured to releasable clamp to a golf cart frame member extending generally horizontally with respect to ground surface that the golf cart is disposed upon.
